(19) United States
(12) Patent Application Publication
(10) Pub. No.: US 2026/0065232 A1
(43) Pub. Date: Mar. 5, 2026

(54) PRE-APPOINTMENT ROUTING USING AN ARTIFICIAL INTELLIGENCE ASSISTANT

(71) Applicant: Wells Fargo Bank, N.A., San Francisco, CA (US)

(72) Inventors: Leah D. Guinyard, Midlothian, TX (US); Jeanette Imai, St. Petersburg, FL (US); Mojgan Madadi, San Mateo, CA (US); Michelle L. Mercado, Las Vegas, NV (US)

(21) Appl. No.: 18/825,390

(22) Filed: Sep. 5, 2024

(51) Int. Cl. G06Q 10/1093; G06Q 30/01

(52) U.S. Cl. CPC G06Q 10/1093; G06Q 30/01

(57) ABSTRACT

Systems and techniques for pre-appointment routing may be used to categorize a branch appointment request. An example technique may include receiving a branch appointment request. The example technique may include using a trained machine learning model to classify the branch appointment request into one of at least two categories. The example technique may include, in accordance with a determination that the branch appointment request is classified in an online category, output a link to perform the associated action for display to a user interface. The example technique may include in accordance with a determination by the trained machine learning model the branch appointment request is classified in an in-person category, output an upload request for a document to the user interface, the document pertaining to the branch appointment request.

### BACKGROUND

In-person service facilities often face challenges managing appointments and walk-in traffic efficiently. Traditional systems may result in long wait times, underutilized staff, or unnecessary trips. External factors like weather conditions and traffic patterns can further complicate operations and customer scheduling.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a system diagram for pre-appointment routing in accordance with some examples.

FIG. 2 illustrates a flowchart for pre-appointment routing using an artificial intelligence (AI) assistant in accordance with some examples.

FIG. 3 illustrates a user device including a user interface for pre-appointment routing in accordance with some examples.

FIG. 4 illustrates a machine learning engine for training and execution related to pre-appointment routing in accordance with some examples.

FIG. 5 illustrates a flowchart showing a technique for pre-appointment routing using an AI assistant in accordance with some examples.

FIG. 6 illustrates generally an example of a block diagram of a machine upon which any one or more of the techniques discussed herein may perform in accordance with some examples.

### DETAILED DESCRIPTION

The systems and techniques described herein provide an AI assistant for pre-appointment routing. An appointment request may be generated at a user device, such as with a downloadable application or webpage accessible from the user device, for an appointment at a financial institution. The appointment request may be classified by a trained machine-learning model into a category, which may direct a customer to an online solution, an ATM, an in-person branch appointment, or the like. The customer may upload a document pertaining to the appointment request, and the trained machine-learning model may verify the document with information stored about the customer in a customer profile datable. By classifying an appointment request and verifying the document pertaining to the appointment, the financial institution may be more efficient at assisting customers than having an in-person branch appointment for each appointment request.

In some examples, the AI assistant described herein may be used to replace a traditional pre-appointment checklist or instruction or assist a banker or a user in navigating a traditional pre-appointment checklist or instruction. Specific request instances may be associated with a customer profile, a customer business structure, an appointment category, a designated purpose for the request (e.g., in identity verification, in customer profile updates, in determining a customer's eligibility for a particular product, service, or offer), or the like. A customer comfortable with AI assistance or self-guided instructions may use the AI assistant described herein to replace a traditional appointment request to complete an action associate with the appointment request. When a customer initiates an appointment request, a bank system may check for data stored in a customer profile database to determine whether the AI assistant may be initiated.

An appointment request may be classified into a category based on an associated action with the appointment request, including an online category, an in-person category, or an ATM category. The appointment request may be classified into the online category when the associated action may be performed online instead of at a branch visit (e.g., in updating a customer profile, in adding or removing a signer from an account, in wiring money, etc.). The appointment request may be classified into the in-person category when the associated action may be performed in-person and the customer may perform the action at a branch visit (e.g., notarizing a document, a large cash withdrawal or deposit, a loan application or consultation, etc.). The appointment request may be classified into the ATM category when the associated action may be performed at an ATM (e.g., a cash advance, a funds transfer, a balance inquiry, a prepaid card reload, etc.).

In some examples, the associated action may depend on the customer business structure (e.g., a personal account, a small business, an LLC, a partnership, a corporation, a cooperative, etc.). For example, a first customer with a personal account, and a second customer with a small business account may make an appointment request for a loan application. The associated action for the first customer may include providing an employer or income verification document, such as a pay stub or bank statement. The associated action for the second customer may include providing a business formation or licensure document, such as an article of incorporation, a franchise agreement, or a business license. In other examples, the associated action may be consistent across business structures, such as an appointment request for notarizing a document. The associated action may include a banking action, such as opening a new account, applying for a credit card, documenting the death of a customer or loved one, adding or removing a signer from an account, wiring money, mortgage signing, or the like.

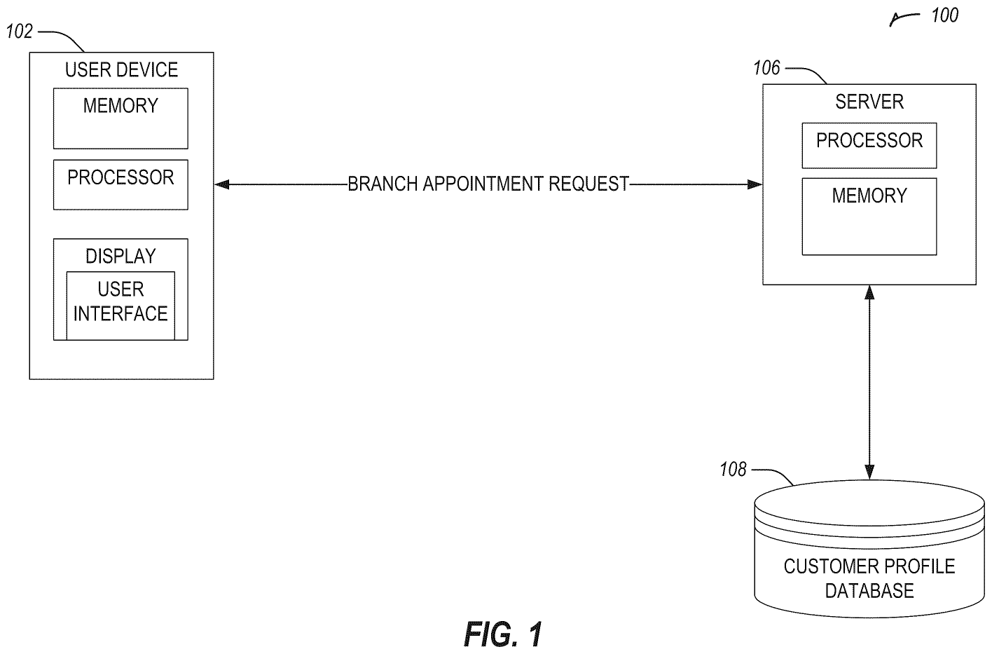

FIG. 1 illustrates a system diagram 100 for pre-appointment routing in accordance with some examples. The system diagram 100 includes a user device 102, which may be used to make a branch appointment request. The request may be sent via a network to a server 106. Information to be sent in response to the request may be stored in a customer profile database 108, which may include a plurality of databases or storage locations. The server 106 may receive the request and classify the request into a category, for example using a processor and memory. The memory of the server 106 may store an algorithm, such as a trained machine learning model, to classify the request into a category in some examples.

In response to classifying a request into a category, information may be obtained from the customer profile database 108 (e.g., account details, holdings, dollar values, etc.) for a user pertaining to the branch appointment request. The server 106 may send a response to the request to the user device 102 or elsewhere (e.g., the request may originate at one device and the response may be sent to a different device). The response may include an indication of the category, an identification of an account pertaining to the branch appointment request, information relating to the branch appointment request, information relating to the accounts pertaining to the branch appointment request, or the like. In some examples, the information in the request or the response may be encrypted, subject to authorization or authentication, or the like. In an example, a classification may differ depending on a customer business structure (e.g., a personal account, an LLC, a partnership, a corporation, a cooperative, etc.).

The user device 102 may include a user device processor and user device memory to generate the request to be sent. The user device 102 may include a display for presenting a user interface to provide information sent from the server 106 in response to the request. In an example, when a user initiates a request (e.g., a branch appointment request), the user device 102 may transmit the request to the server 106. After receiving the request from the user device 102, the server 106 may send a response to the user device 102, for example including an indication that the request has been classified into a category. The response may include an additional instruction to assist a user with completing an action associated with the request.

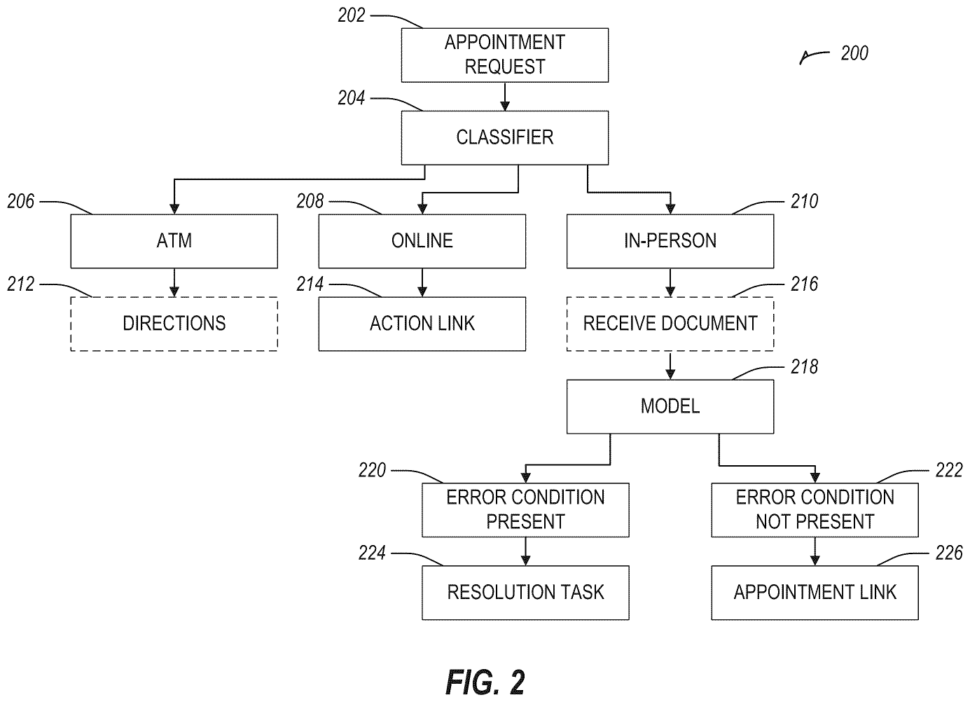

The server 106 may include a server processor and server memory to receive data indicating a branch appointment request from the user device 102 and to generate a response. The server processor may use the data, or other data stored in the server memory or a customer profile database 108 to classify the branch appointment request into a category. More detail regarding the data flow and processing are provided with reference to FIG. 2.

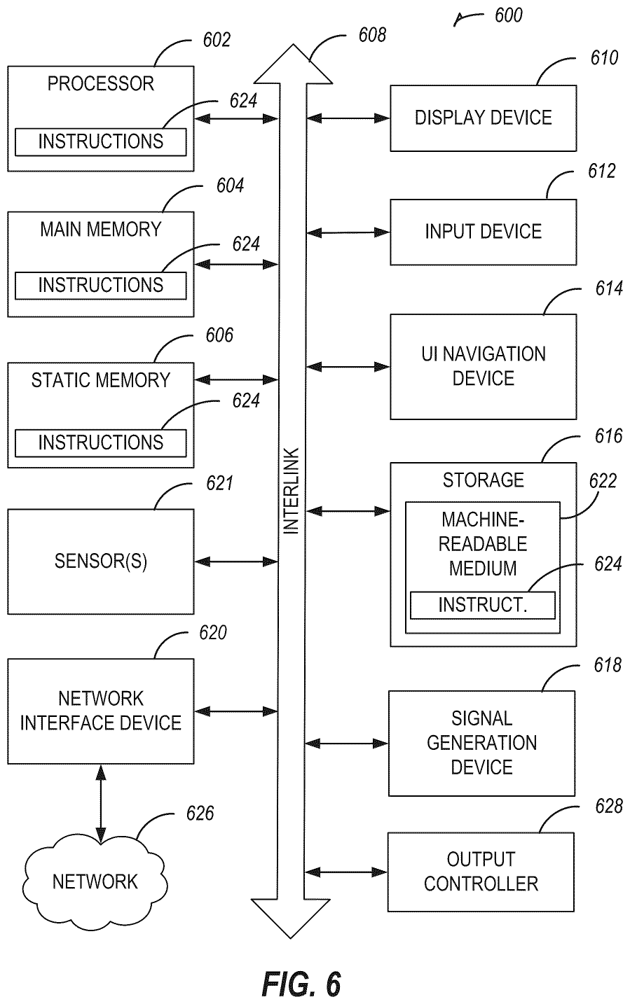

FIG. 2 illustrates a flowchart showing a technique 200 for pre-appointment routing using an AI assistant in accordance with some examples. In an example, operations of the technique 200 may be performed by processing circuitry, for example by executing instructions stored in memory. The processing circuitry may include a processor, a system on a chip, or other circuitry (e.g., wiring). For example, the technique 200 may be performed by processing circuitry of a device (or one or more hardware or software components thereof), such as those illustrated and described with reference to FIG. 6.

The technique 200 includes an operation 202 to receive a branch appointment request. A branch appointment request may be for personal or business purposes and may include a branch appointment request reason. The request reason may include a pre-generated request reason or a user-made custom request. The branch appointment request reason may be used to help determine an associated action to be performed, such as by referencing a checklist associated with the appointment request reason. The branch appointment request may include an associated action to be performed. The associated action may depend on a branch appointment request reason. For example, when the appointment request contains a pre-generated appointment request reason, the associated action may be automatically determined based on a checklist associated with the pre-generated appointment request reason.

The technique 200 includes an operation 204 to, in response to receiving a branch appointment request, automatically classify, for example using processing circuitry, the branch appointment request into a category. The category may be selected based on an associated action related to the branch appointment request. These categories may include an ATM category 206, indicating the associated action may be performed at an ATM. Associated actions that may be performed at an ATM may include, for example, a cash advance, a funds transfer, a balance inquiry, or a prepaid card reload. The categories may include an online category 208, indicating the associated action is performable online. Associated actions classified into the online category may include actions that a user may complete online without branch assistance. Associated actions that may be performed online may include, for example, updating a customer profile, adding or removing a signer from an account, wiring money, or filing a fraud claim. The categories may include an in-person category 210, indicating the associated action is performable at a branch. Associated actions classified into the in-person category may be too complex for a user to do alone by the user, or may require additional authorization. Associated actions that may be performed in-person may include, for example, notarizing a document, a large cash withdrawal or deposit, a loan application or consultation, or the like. In some examples, operation 204 includes using a trained machine learning model to automatically classify the branch appointment request into a category.

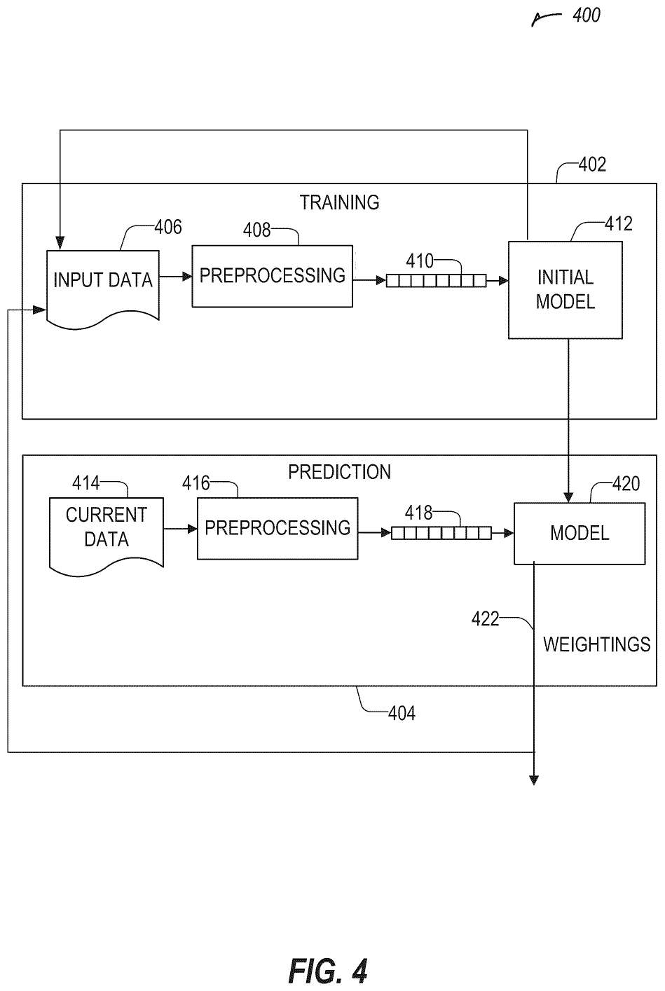

Classification may be performed using one or more various algorithms or machine learning models. For example, an appointment request may be provided for classification or learning to a proactive machine learning model or a reactive machine learning model, which are described in more detail with respect to FIG. 4. Additionally or alternatively, the appointment request may be provided for classification to other algorithms or for manual intervention at operation 204. Either of the proactive machine learning model or the reactive machine learning model, may be used to perform classification. In some examples, the proactive machine learning model may be used to proactively predict the classification of the appointment request based on an appointment request category (e.g., fraud claim, money withdrawal, profile update, or the like), a variable related to a customer (e.g., previous appointment request classification results, an age of the customer, a preference selected by the customer, a business structure of the customer, or the like), or branch availability. In other examples, the reactive machine learning model may be trained in a reactive fashion to have a set of rules that can reactively classify the appointment request to counter abnormal requests, such as a custom entry appointment request category, a new customer, or the like. In at least these examples, a set of rules can be used to react to a particular event or, in a predictive sense, to provide a rule for handling an imminent request.

The technique 200 includes an operation 212 to optionally, in response to classifying the branch appointment request into the ATM category 206, provide directions to an ATM. The directions may be provided through an application on a user device (e.g., Google Maps, Apple Maps, Waze, etc.), a webpage (e.g., maps.google.com, mapquest.com, etc.), a portable document highlighting ATM locations (e.g., a PDF, HTML, etc.), an address of an ATM, or the like. The directions may include a list of nearby ATMs, for example organized by distance from a location of the user device. The location of the user device may be automatically determined or may be manually input by the user. In an example, the directions may be generated in response to a branch appointment request to transfer funds. The directions may be to the geographically nearest ATM to a user device, or a geographically nearest ATM to a user selected location. The directions may be provided according to a device, display, or user interface to be used to show the directions (e.g., different provided directions for a phone, a website, a tablet, etc.).

The technique 200 includes an operation 214 to, in response to classifying a branch appointment request into the online category 208, output a link to a user interface to perform an associated action online. The link may be to a page on a banking application, a webpage, a pop-up, a redirection to a different page on a downloadable application, or the like. The link may direct a user to a page where the user may perform the associated action, or an instruction for performing the associated action online, or a page containing commonly asked questions, or to an AI model for assistance over chat, or any combination thereof. The information may be viewer-dependent (e.g., different context for a personal account, different context for a small business, or for a particular device). In some examples, the link may be selected according to a device, display, or user interface to be used to show the link (e.g., different information for a phone, a website, an application, etc.).

The technique 200 includes an operation 216 to, in response to classifying a branch appointment request into the in-person category, optionally output an upload request for information or a document to a user interface, send an indication that a user should proceed to a branch, provide an appointment user interface component, usable to make an appointment in a branch, or the like. When a document is requested, the information or document may be requested based on information needed for a branch appointment. The information or document may be parsed and data may be stored in a customer profile database. The information or document may be saved to the customer profile database, and may optionally overwrite or supplement existing data in the customer profile database. In some examples, the information or document may include an identification form, which may include an expiration date. In an example, the information or document may include a form that may have blank spots or drop downs for a user to fill in with relevant information. The information or document may be relevant to a financial institution, such as a balance sheet, an application form, an account statement, a loan application form, a mortgage application, an approval document, a withdrawal or deposit slip, a purchase order, or the like. In some examples, the operation 216 may output a blank version of the information or document to the user interface alongside a request for completed information or document.

The technique 200 includes an operation 218 to, in response to receiving a document, automatically verify, for example, using processing circuitry, a document status. The document may be in a first status 220 in which an error condition is present, or in a second status 222 in which an error condition is not present. In some examples, a document may be checked for status on a more granular level, for example by page or section, and in these examples the document may have both statuses or a third status. Similarly, in some examples a set of documents may be assigned a status together (e.g., a loan application with a single error may be classified in the first status 220). Error conditions may include an empty field on a document indicating a missing piece of information, an expired document, a document with information that does not match stored information about a customer, or the like. In an example, an error condition may be verified based on information on the document compared to information stored on a customer profile database, indicating the information on the document may not match the information stored on the customer profile database. In an example, an error condition may be verified based on information missing from the document, indicating the document is missing information. In some examples, operation 218 includes using a trained machine learning model to verify whether an error condition is present.

The technique 200 includes an operation 224 to, in response to a verification that a document contains an error condition, output a resolution task to resolve the error condition. A resolution task may be error-condition-dependent (e.g., a different task for missing information, a different task for an expired document or a different task for mismatched information between a document and stored information about a customer). For example, a resolution task may include an option to update an existing customer profile to match information included in the document. In some examples, a resolution task may include an option to receive new information from the customer to populate empty fields in the document. The resolution task may be output to a user interface, and may include a link to an error code. The error code may assist the customer with identifying the error condition and associated resolution task. In some examples, the operation 224 may include a second upload request for a second document to the user interface. The second document may be a modified version of a first document, and may be verified as a second status 222 in which an error condition is no longer present.

The technique 200 includes an operation 226 to, in response to a verification that a document does not contain an error condition, output a link to schedule a branch appointment according to a branch appointment request for display on a user interface. The link may be to a page on a banking application, a webpage, a pop-up, a redirection to a different page on a downloadable application, or the like. The link may direct a user to a page where the user may schedule a branch appointment. In some examples, the operation 226 may save the document to a customer profile on a server. The document may be provided to the branch when a customer arrives at the branch for an appointment. In some examples, when the document is provided to the branch, information is provided to a bank teller to assist with an associated action of a branch appointment. The information may be viewer-dependent (e.g., different context for a personal account, different context for a small business, or for a particular device). In some examples, the link may be selected according to a device, display, or user interface to be used to show the link (e.g., different information for a phone, a website, an application, etc.).

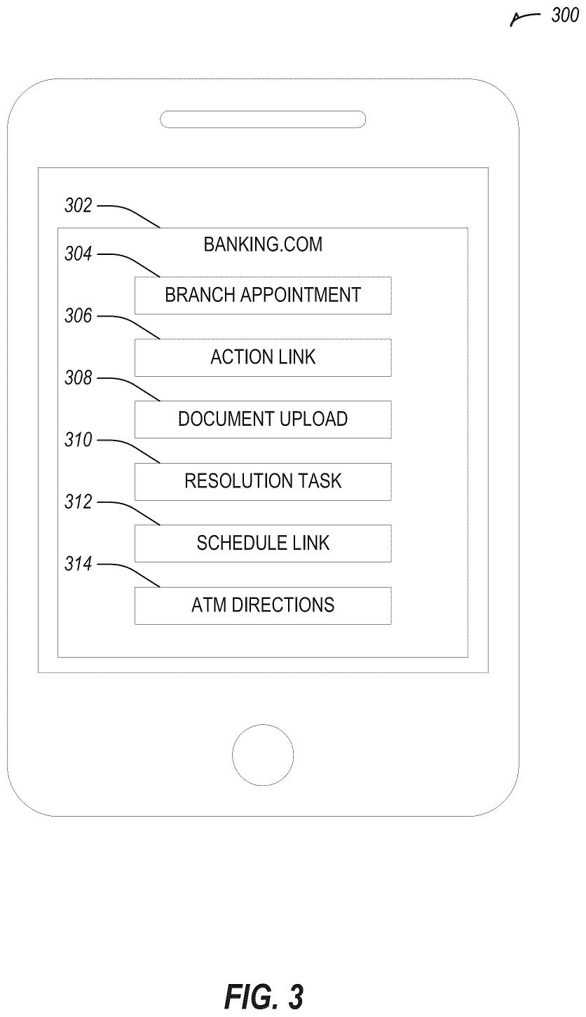

FIG. 3 illustrates a user device 300 including a user interface for pre-appointment routing in accordance with some examples. The user interface can display a banking app component 302. The banking app component 302 illustrates example selectable indications, such as a branch appointment selectable indication 304, an action link selectable indication 306, a document upload selectable indication 308, a resolution task selectable indication 310, a schedule link selectable indication 312, and an ATM directions selectable indication 314. These selectable indications are shown on a single user interface for convenience but may be displayed on separate user interfaces, may be displayed individually, as part of user interfaces with other information or selectable indications, or may not each be displayed.

The banking app component 302 may include a downloadable application (e.g., a mobile app), a webpage, or the like.

The branch appointment selectable indication 304 may be selected to initiate a branch appointment request (e.g., to a server 106, such as described with respect to FIGS. 1-2 above). The branch appointment selectable indication 304 may activate a request field containing pre-generated branch appointment request reasons, such as opening a new account, applying for a credit card, applying for a loan, discussing business lending, or the like. The request field may contain a custom entry option for a user to describe a custom branch appointment request reason. In some examples, the branch appointment selectable indication 304 may be used to resume a branch appointment request that may have been initiated via a website, an app (e.g., a mobile app), a text, an email, a phone call, etc. In some examples, selectable indications 306, 308, 310, 312, 314, or any combination thereof may not be available until after a branch appointment request is completed.

The action link selectable indication 306 may be selected to be redirected to a page that may assist with performing the associated action online. The page may include commonly asked questions, a step-by-step instruction for performing the associated action, assistance from an artificial intelligence model (e.g., a chat bot), an option to text or call with an operator, or the like. The page may be a new page on the banking app component, a new webpage, a pop-up, a redirection to a different page on a downloadable application, or the like.

The document upload selectable indication 308 may be selected to upload a document pertaining to the branch appointment request (e.g., to a server 106, such as described with respect to FIGS. 1-2 above). The document upload selectable indication 308 may accept various document file types (e.g., .pdf, .docx, .doc, .xlsx, etc.). The document upload selectable indication 308 may offer one or more methods of document upload. In some examples, a user may select a file from a device system. In other examples, a user may access a device camera to capture a photo of a document. In some examples, a user may drag and drop a file into a window. In some examples, the document upload selectable indication 308 may include information detailing what type of document to upload. In some examples, the document may be linked to a customer (e.g., the customer profile database, such as described with respect to FIG. 1 above). The document may be viewed from the document upload selectable indication 308. In some examples, the document upload selectable indication 308 may be selected to upload a second document. The second document may replace the document, or may be maintained alongside the document. In some examples, selectable indications 310, 312, 314, or any combination thereof may not be available until after a document is uploaded.

The resolution task selectable indication 310 may be used to view a resolution task (e.g., to resolve an error condition within a document, such as described with respect to FIG. 2 above). The resolution task selectable indication 310 may be used to resolve the error condition, or may be used as a link to view instructions to resolving the error condition. In some examples, the resolution task selectable indication 310 may be selected to be redirected to an error code. The error code may assist a customer with identifying the error condition. In other examples, the resolution task selectable indication 310 may be selected to modify information on the document or to populate empty fields on the document to resolve the error condition. In other examples, the resolution task selectable indication 310 may include a prompt for a user to overwrite information in a customer profile database with information in the document.

The schedule link selectable indication 312 may be selected to be redirected to a webpage, a pop-up, an application on the user device, or the like, to schedule an appointment (e.g., at a branch, such as described with respect to FIG. 2 above). In some examples, the schedule link selectable indication 312 may automatically direct a user to a geographically near branch based on a current location of the user. The user may populate a location field to find one or more branches geographically near a user-selected location, rather than the current location of a user.

The ATM directions selectable indication 314 may be selected to receive directions to a nearby ATM based on the location of a user. The ATM directions selectable indication 314 may redirect a user to an application on a user device (e.g., a map app on a phone, etc.), a webpage, a portable document highlighting one or more ATM locations (e.g., a PDF, HTML, etc.), an address of an ATM, or the like.

FIG. 4 illustrates a machine learning engine for training and execution related to an AI assistant for pre-appointment in accordance with some examples. The machine learning engine may be deployed to execute at a mobile device (e.g., a cell phone) or a computer (e.g., an orchestrator server). A system may calculate one or more weightings for criteria based upon one or more machine learning algorithms. FIG. 4 shows an example machine learning engine 400 according to some examples of the present disclosure.

Machine learning engine 400 uses a training engine 402 and a prediction engine 404. Training engine 402 uses input data 406, for example after undergoing preprocessing component 408, to determine one or more features 410. The one or more features 410 may be used to generate an initial model 412, which may be updated iteratively or with future labeled or unlabeled data (e.g., during reinforcement learning), for example to improve the performance of the prediction engine 404 or the initial model 412. An improved model may be redeployed for use.

The input data 406 may include a purpose for a request (e.g., a user for data related to the grouping, a requesting entity status such as internal, external, in identity verification, personal use of a user, for backup, for determining a user's eligibility for a particular product, service, or offer, or the like), a requestor (e.g., a job title, a company name, an entity requesting, etc.), a user or client (e.g., a person whose accounts are under consideration), or the like. The input data 406 may include real world or simulated accounts that are unlabeled or labeled with contextual account groupings, for example with an identified purpose, user, client, etc. The input data 406 may include a request for an in-branch meeting, a request for a pre-scheduled ATM transaction, a request for an online resource, or the like.

In the prediction engine 404, current data 414 (e.g., information received in a request, such as via an API, which may include a request, a user, a use, a client, etc.) may be input to preprocessing component 416. In some examples, preprocessing component 416 and preprocessing component 408 are the same. The prediction engine 404 produces feature vector 418 from the preprocessed current data, which is input into the model 420 to generate one or more criteria weightings 422. The criteria weightings 422 may be used to output a prediction, as discussed further below.

The training engine 402 may operate in an offline manner to train the model 420 (e.g., on a server). The prediction engine 404 may be designed to operate in an online manner (e.g., in real-time, at a mobile device, on a wearable device, etc.). In some examples, the model 420 may be periodically updated via additional training (e.g., via updated input data 406 or based on labeled or unlabeled data output in the weightings 422) or based on identified future data, such as by using reinforcement learning to personalize a general model (e.g., the initial model 412) to a particular user.

Labels for the input data 406 may include whether a corresponding request resulted or should have resulted in an in-branch appointment, an ATM visit, an online transaction, a chat bot communication, or the like. In some examples, a label may include a list of accounts, a type of account, an account grouping, a context term (e.g., a request may be labeled with a “regulatory” term or a “mortgage” term, etc.), or the like.

The initial model 412 may be updated using further input data 406 until a satisfactory model 420 is generated. The model 420 generation may be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 402 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 402. In an example, a regression model is used and the model 420 is a vector of coefficients corresponding to a learned importance for each of the features in the vector of features 410, 418. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like.

Once trained, the model 420 may output an appointment request category, an error condition classification, or the like. In some examples, the model 420 may output a list of associated actions corresponding to a determined appointment request category, a list of associated errors, etc. The model 420 may integrate or be supplemented with an additional algorithm that outputs relevant information related to the determined appointment request category or the determined error condition, in some examples. The model 420 may output context or metadata related to how the determined appointment request category was selected or an error condition was detected, in some examples.

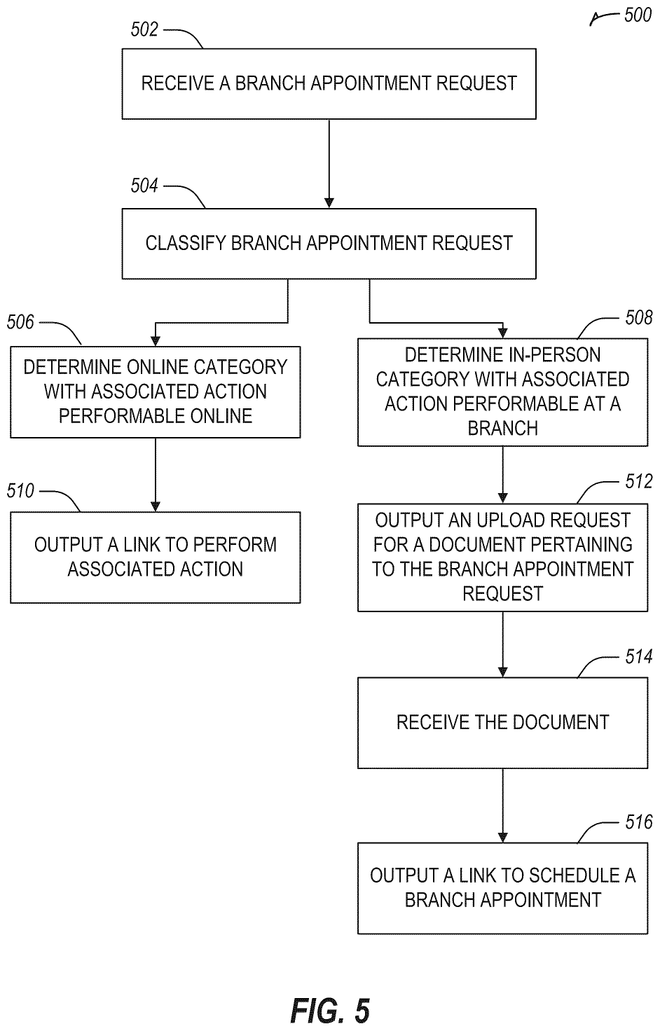

FIG. 5 illustrates a flowchart showing a technique 500 for pre-appointment routing using an AI assistant in accordance with some examples. In an example, operations of the technique 500 may be performed by processing circuitry, for example by the server processor in FIG. 1, or by executing instructions stored in memory. The processing circuitry may include a processor, a system on a chip, or other circuitry (e.g., wiring). For example, technique 500 may be performed by processing circuitry of a device (or a hardware or software component thereof), such as those illustrated and described with reference to FIG. 6.

The technique 500 includes an operation 502 to receive a branch appointment request. The branch appointment request may be initiated by a customer through a user interface, such as the user interface described in FIG. 3. The branch appointment request may include an associated action. The associated action may depend on a business structure of the customer. The technique 500 includes an operation 504 to, in response to receiving the appointment request, automatically classify, for example using processing circuitry, such as to implement a trained machine learning model, the branch appointment request into one of at least two categories. A category may be selected based on an associated action related to the branch appointment request. The associated action may be classified as an action that is performable without branch assistance, or as an action that is performable with branch assistance. In some examples, operation 504 includes using a trained machine learning model.

The technique 500 includes an operation 506 to determine the branch appointment request corresponds to an online category, indicating that the associated action is performable online. The associated action is performable online when the action is performable by a user without branch assistance, such as updating a customer profile, adding or removing a signer from an account, wiring money, filing a fraud claim, or the like.

The technique 500 includes an operation 508 to determine the branch appointment request corresponds to an in-person category, indicating an associated action is performable at a branch location. The associated action is performable at a branch location when the associated action may use a teller or other financial institution employee for assistance, such as notarizing a document, a large cash withdrawal or deposit, a loan application or consultation, or the like.

The technique 500 includes an operation 510 to, in response to a branch appointment request determined to be within an online category, output a link to perform an associated action online. The link may direct a user to a page where the user may perform the associated action online. The page may include assistance from an AI model, a link to instructions to guide the user to perform the associated action online, a link to commonly asked questions, or any combination thereof. The link may be dependent on the business model or device of a user.

The technique 500 may optionally include an operation to determine the branch appointment request corresponds to an automatic teller machine category, indicating the associated action is performable at an automatic teller machine. In response to determining that the branch appointment request can be within the automatic teller machine category, directions to the automatic teller machine may be provided.

The technique 500 includes an operation 512 to, in response to a branch appointment request determined to be within an in-person category, output an upload request for a document pertaining to the branch appointment request. The document may pertain to the branch appointment request. The document may be a document typically used in financial transactions, such as an identification document, a balance sheet, an application form, an account statement, a loan application form, a mortgage application, an approval document, a withdrawal or deposit slip, a purchase order, or the like. The document may contain information stored in a customer profile in a customer profile database. In some examples, the information stored in the customer profile database may not match the information stored in the document. The document may overwrite the information stored in the customer profile database.

The technique 500 includes an operation 514 to receive a document from the customer. The document may be saved to a customer profile in a customer profile database. The document may be viewed by the customer, employees of a financial institute, an authorized user, or a combination thereof. In some examples, a second document may be uploaded. In some examples, the second document may overwrite the document. In other examples, the second document may be maintained alongside the document. Optionally, in response to receiving the document from the customer, a trained machine-learning model may verify whether an error condition is present. If the trained machine-learning model verifies that an error condition is present, a resolution task may be output. The resolution task may resolve the error condition. Optionally, in response to outputting the resolution task, a second upload request for the second document may be output on a user interface. The second document may resolve the error condition. In response to receiving the second document from the customer, a link to schedule a branch appointment may be displayed on the user interface. If the trained machine-learning model verifies that an error condition is not present, a link to schedule the branch appointment according to the branch appointment request may be output for display on the user interface. The error condition may depend on the document received from the customer. The resolution task may depend on the error condition. In some examples, the error condition may include information included in the document that does not match a customer profile, and the resolution task may include an option to update the customer profile to match the information included in the document. In other examples, the document may be an identification document, and the error condition may be determined based on an expiration date of the identification document. In other examples, the error condition may be present when information is absent from the document, and the resolution task may include an option to receive new information from the customer. The new information may populate the document.

The technique 500 includes an operation 516 to, in response to receiving the document, output a link to schedule a branch appointment according to a branch appointment request. The link may direct a user to a page where the user may schedule a branch appointment (e.g., an online page, an email, a phone number, etc.). The link may be dependent on the business model or device of a user. Optionally, the customer may be prompted to visit a branch for the branch appointment. The document may be saved to a customer profile on a server for access by the customer or a branch employee. The document may be provided to the branch in response to receiving an indication from the branch when the customer is at the branch, such as through a check-in process, geolocation tag, or the like. Optionally, providing the document to the branch may include providing information to the branch employee, such as a branch teller, to assist with the associated action of the branch appointment request.

FIG. 6 illustrates generally an example of a block diagram of a machine 600 upon which any technique (e.g., methodologies) discussed herein may perform in accordance with some examples. In alternative examples, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any methodology discussed herein, such as cloud computing, software as a service (Saas), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

A machine (e.g., a computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

The following, non-limiting examples, detail certain aspects of the present subject matter to solve the challenges and provide the benefits discussed herein, among others.
Example 1 is at least one non-transitory machine-readable medium including instructions, which when executed by processing circuitry, cause the processing circuitry to perform operations to: receive, via a user interface, a branch appointment request from a customer, the branch appointment request having an associated action; use a trained machine learning model to classify the branch appointment request into one of at least two categories, the at least two categories including: an online category indicating the associated action is performable online; and an in-person category indicating the associated action is performable at a branch; output, for display to the user interface, in accordance with a determination by the trained machine learning model that the branch appointment request is classified in the online category, a link to perform the associated action; in accordance with a determination by the trained machine learning model that the branch appointment request is classified in the in-person category: output an upload request for a document to the user interface, the document pertaining to the branch appointment request; receive the document from the customer; and output a link to schedule a branch appointment according to the branch appointment request.
In Example 2, the subject matter of Example 1 optionally includes wherein the operations further cause the processing circuitry to: in response to receiving the document, verify, with the trained machine learning model, whether an error condition is present; in accordance with a determination by the trained machine learning model that the error condition is present, output a resolution task to resolve the error condition; and in accordance with a determination by the trained machine learning model that the error condition is not present, output, for display on the user interface, the link to schedule the branch appointment according to the branch appointment request.
In Example 3, the subject matter of Example 2 optionally includes wherein: the error condition includes information included in the document that does not match a customer profile; and the resolution task includes an option to update the customer profile to match the information included in the document.
In Example 4, the subject matter of any one or more of Examples 2-3 optionally include wherein the document is an identification document, and further determining the error condition based on an expiration date of the identification document.
In Example 5, the subject matter of any one or more of Examples 2-4 optionally include wherein: the error condition is present when information is absent from the document; and the resolution task includes an option to receive new information from the customer, the new information populating the document.
In Example 6, the subject matter of any one or more of Examples 2-5 optionally include wherein the operations further cause the processing circuitry to: output, in response to outputting the resolution task, a second upload request for a second document to the user interface, the second document resolving the error condition; and receive the second document from the customer, wherein to output the link to schedule a branch appointment includes to output the link in response to receiving the second document.
In Example 7, the subject matter of any one or more of Examples 1-6 optionally include wherein the operations further cause the processing circuitry to: classify the branch appointment request into a third category, the third category indicating the associated action is performable at an automatic teller machine; and provide directions to the automatic teller machine.
In Example 8, the subject matter of any one or more of Examples 1-7 optionally include wherein the operations further cause the processing circuitry to: prompt the customer to visit a branch; save the document to a customer profile on a server; and provide the document to the branch in response to receiving an indication from the branch when the customer is at the branch.
In Example 9, the subject matter of Example 8 optionally includes wherein providing the document to the branch includes providing information to a branch teller to assist with the associated action of the branch appointment request.
In Example 10, the subject matter of any one or more of Examples 1-9 optionally include wherein the associated action depends on a business structure of the customer.
Example 11 is a system comprising: processing circuitry; and memory, including instructions, which when executed by the processing circuitry, cause the processing circuitry to: receive, via a user interface, a branch appointment request from a customer, the branch appointment request having an associated action; use a trained machine learning model to classify the branch appointment request into one of at least two categories, the at least two categories including: an online category indicating the associated action is performable online; and an in-person category indicating the associated action is performable at a branch; output, for display to the user interface, in accordance with a determination by the trained machine learning model that the branch appointment request is classified in the online category, a link to perform the associated action; in accordance with a determination by the trained machine learning model that the branch appointment request is classified in the in-person category: output an upload request for a document to the user interface, the document pertaining to the branch appointment request; receive the document from the customer; and output a link to schedule a branch appointment according to the branch appointment request.
In Example 12, the subject matter of Example 11 optionally includes wherein the instructions further cause the processing circuitry to: in response to receiving the document, verify, with the trained machine learning model, whether an error condition is present; in accordance with a determination by the trained machine learning model that the error condition is present, output a resolution task to resolve the error condition; and in accordance with a determination by the trained machine learning model that the error condition is not present, output, for display on the user interface, the link to schedule the branch appointment according to the branch appointment request.
In Example 13, the subject matter of Example 12 optionally includes wherein: the error condition includes information included in the document that does not match a customer profile; and the resolution task includes an option to update the customer profile to match the information included in the document.
In Example 14, the subject matter of any one or more of Examples 12-13 optionally include wherein the document is an identification document, and further determining the error condition based on an expiration date of the identification document.
In Example 15, the subject matter of any one or more of Examples 12-14 optionally include wherein: the error condition is present when information is absent from the document; and the resolution task includes an option to receive new information from the customer, the new information populating the document.
In Example 16, the subject matter of any one or more of Examples 12-15 optionally include wherein the instructions further cause the processing circuitry to: output, in response to outputting the resolution task, a second upload request for a second document to the user interface, the second document resolving the error condition; and receive the second document from the customer, wherein to output the link to schedule a branch appointment includes to output the link in response to receiving the second document.
In Example 17, the subject matter of any one or more of Examples 11-16 optionally include wherein the instructions further cause the processing circuitry to: classify the branch appointment request into a third category, the third category indicating the associated action is performable at an automatic teller machine; and provide directions to the automatic teller machine.
In Example 18, the subject matter of any one or more of Examples 11-17 optionally include wherein the instructions further cause the processing circuitry to: prompt the customer to visit a branch; save the document to a customer profile on a server; and provide the document to the branch in response to receiving an indication from the branch when the customer is at the branch.
In Example 19, the subject matter of Example 18 optionally includes wherein providing the document to the branch includes providing information to a branch teller to assist with the associated action of the branch appointment request.
In Example 20, the subject matter of any one or more of Examples 11-19 optionally include wherein the associated action depends on a business structure of the customer.
Example 21 is at least one machine-readable medium including instructions that, when executed by processing circuitry, cause the processing circuitry to perform operations to implement of any of Examples 1-20.
Example 22 is an apparatus comprising means to implement of any of Examples 1-20.
Example 23 is a system to implement of any of Examples 1-20.
Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. At least one non-transitory machine-readable medium including instructions, which when executed by processing circuitry, cause the processing circuitry to perform operations to:
receive, via a user interface, a branch appointment request from a customer, the branch appointment request having an associated action;
use a trained machine learning model to classify the branch appointment request into one of at least two categories, the at least two categories including:
an online category indicating the associated action is performable online; and
an in-person category indicating the associated action is performable at a branch;
output, for display to the user interface, in accordance with a determination by the trained machine learning model that the branch appointment request is classified in the online category, a link to perform the associated action; and
in accordance with a determination by the trained machine learning model that the branch appointment request is classified in the in-person category:
output an upload request for a document to the user interface, the document pertaining to the branch appointment request;
receive the document from the customer; and
output a link to schedule a branch appointment according to the branch appointment request.

2. The at least one non-transitory machine-readable medium of claim 1, wherein the operations further cause the processing circuitry to:
in response to receiving the document, verify, with the trained machine learning model, whether an error condition is present;
in accordance with a determination by the trained machine learning model that the error condition is present, output a resolution task to resolve the error condition; and
in accordance with a determination by the trained machine learning model that the error condition is not present, output, for display on the user interface, the link to schedule the branch appointment according to the branch appointment request.

3. The at least one non-transitory machine-readable medium of claim 2, wherein:
the error condition includes information included in the document that does not match a customer profile; and
the resolution task includes an option to update the customer profile to match the information included in the document.

4. The at least one non-transitory machine-readable medium of claim 2, wherein the document is an identification document, and further determining the error condition based on an expiration date of the identification document.

5. The at least one non-transitory machine-readable medium of claim 2, wherein:
the error condition is present when information is absent from the document; and
the resolution task includes an option to receive new information from the customer, the new information populating the document.

6. The at least one non-transitory machine-readable medium of claim 2, wherein the operations further cause the processing circuitry to:
output, in response to outputting the resolution task, a second upload request for a second document to the user interface, the second document resolving the error condition; and
receive the second document from the customer, wherein to output the link to schedule the branch appointment includes to output the link in response to receiving the second document.

7. The at least one non-transitory machine-readable medium of claim 1, wherein the operations further cause the processing circuitry to:
classify the branch appointment request into a third category, the third category indicating the associated action is performable at an automatic teller machine; and
provide directions to the automatic teller machine.

8. The at least one non-transitory machine-readable medium of claim 1, wherein the operations further cause the processing circuitry to:
prompt the customer to visit the branch;
save the document to a customer profile on a server; and
provide the document to the branch in response to receiving an indication from the branch when the customer is at the branch.

9. The at least one non-transitory machine-readable medium of claim 8, wherein providing the document to the branch includes providing information to a branch teller to assist with the associated action of the branch appointment request.

10. The at least one non-transitory machine-readable medium of claim 1, wherein the associated action depends on a business structure of the customer.

11. A system comprising:
processing circuitry; and
memory, including instructions, which when executed by the processing circuitry, cause the processing circuitry to:
receive, via a user interface, a branch appointment request from a customer, the branch appointment request having an associated action;
use a trained machine learning model to classify the branch appointment request into one of at least two categories, the at least two categories including:
an online category indicating the associated action is performable online; and
an in-person category indicating the associated action is performable at a branch; and
output, for display to the user interface, in accordance with a determination by the trained machine learning model that the branch appointment request is classified in the online category, a link to perform the associated action;
in accordance with a determination by the trained machine learning model that the branch appointment request is classified in the in-person category:
output an upload request for a document to the user interface, the document pertaining to the branch appointment request;
receive the document from the customer; and
output a link to schedule a branch appointment according to the branch appointment request.

12. The system of claim 11, wherein the instructions further cause the processing circuitry to:
in response to receiving the document, verify, with the trained machine learning model, whether an error condition is present;
in accordance with a determination by the trained machine learning model that the error condition is present, output a resolution task to resolve the error condition; and
in accordance with a determination by the trained machine learning model that the error condition is not present, output, for display on the user interface, the link to schedule the branch appointment according to the branch appointment request.

13. The system of claim 12, wherein:
the error condition includes information included in the document that does not match a customer profile; and
the resolution task includes an option to update the customer profile to match the information included in the document.

14. The system of claim 12, wherein the document is an identification document, and further determining the error condition based on an expiration date of the identification document.

15. The system of claim 12, wherein:
the error condition is present when information is absent from the document; and
the resolution task includes an option to receive new information from the customer, the new information populating the document.

16. The system of claim 12, wherein the instructions further cause the processing circuitry to:
output, in response to outputting the resolution task, a second upload request for a second document to the user interface, the second document resolving the error condition; and
receive the second document from the customer, wherein to output the link to schedule the branch appointment includes to output the link in response to receiving the second document.

17. The system of claim 11, wherein the instructions further cause the processing circuitry to:
classify the branch appointment request into a third category, the third category indicating the associated action is performable at an automatic teller machine; and
provide directions to the automatic teller machine.

18. The system of claim 11, wherein the instructions further cause the processing circuitry to:
prompt the customer to visit the branch;
save the document to a customer profile on a server; and
provide the document to the branch in response to receiving an indication from the branch when the customer is at the branch.

19. The system of claim 18, wherein providing the document to the branch includes providing information to a branch teller to assist with the associated action of the branch appointment request.

20. The system of claim 11, wherein the associated action depends on a business structure of the customer.
